(19) United States
(12) Patent Application Publication
(10) Pub. No.: US 2023/0034765 A1
(43) Pub. Date: Feb. 2, 2023

(54) POLISHING AMOUNT ESTIMATION DEVICE

(71) Applicant: Fanuc Corporation, Minamitsuru-gun, Yamanashi (JP)

(72) Inventor: Mikito Hane, Minamitsuru-gun, Yamanashi (JP)

(73) Assignee: Fanuc Corporation, Minamitsuru-gun, Yamanashi (JP)

(21) Appl. No.: 17/791,311

(22) PCT Filed: Jan. 13, 2021
(86) PCT No.: PCT/JP2021/000896

§ 371 Date: Jul. 7, 2022

(30) Foreign Application Priority Data
Jan. 20, 2020 (JP) 2020-006843

(51) Int. Cl. B24B 49/04; B24B 49/12; B24B 49/10; B25J 13/08; B25J 9/16

(52) U.S. Cl. CPC B24B 49/04; B24B 49/12; B24B 49/10; B25J 13/08; B25J 9/1656

(57) ABSTRACT

There is provided a polishing amount estimation device which can facilitate the setting of parameters of teaching trajectory or force control in a polishing operation. A polishing amount estimation device for estimating a polishing amount in a polishing operation which is performed by bringing a polishing tool mounted on a robot manipulator into contact with a target workpiece by force control includes a memory which stores a motion program, and a polishing amount estimation part configured to estimate the polishing amount based on at least one of a motion trajectory of the polishing tool, a movement speed of the polishing tool, and a pressing force of the polishing tool against the target workpiece, which are obtained based on the motion program.

### CROSS REFERENCE TO RELATED APPLICATIONS

This is the U.S. National Phase application of PCT/JP2021/000896, filed Jan. 13, 2021, which claims priority to Japanese Patent Application No. 2020-006843, filed Jan. 20, 2020, the disclosures of these applications being incorporated herein by reference in their entireties for all purposes.

The present invention relates to a polishing amount estimation device.

### BACKGROUND OF THE INVENTION

By equipping a robot manipulator with a force sensor, it is possible to detect forces applied to a workpiece and perform advanced operations such as exploration operations, fitting operations, and polishing while performing force control. As such a robot systems, a system which is configured to display the force detected by a force sensor is also known (refer to, for example, Patent Literature 1).

### PATENT LITERATURE

[PTL 1] Japanese Unexamined Patent Publication (Kokai) No. 2017-1122

### SUMMARY OF THE INVENTION

However, skilled parameter adjustment ability is required to properly perform force control operations such as polishing operations. In general, in order to perform such parameter adjustment, it is necessary for an operator to repeatedly fail and succeed in force control to acquire parameter setting know-how. A polishing amount estimation device which can facilitate parameter setting of a teaching trajectory or force control in a polishing operation is desired.

One aspect of the present disclosure provides a polishing amount estimation device for estimating a polishing amount in a polishing operation which is performed by bringing a polishing tool mounted on a robot manipulator into contact with a target workpiece by force control, the polishing amount estimation device comprising a memory which stores a motion program, and a polishing amount estimation part configured to estimate the polishing amount based on at least one of a motion trajectory of the polishing tool, a movement speed of the polishing tool, and a pressing force of the polishing tool against the target workpiece, which are obtained based on the motion program.

According to the above configuration, an operator can intuitively understand an estimated polishing amount, and can easily carry out teaching trajectory and force control parameter adjustment.

From the detailed description of typical embodiments of the invention shown in the attached drawings, the objective, features, and advantages of the invention as well as other objectives, features, and advantages will be further clarified.

### BRIEF DESCRIPTION OF DRAWINGS

FIG. 1 is a system configuration view of a robot system including a controller as a simulation device according to an embodiment.

FIG. 2 shows a structural example of a robot system.

FIG. 3 shows another structure example of a robot system.

FIG. 4 is a functional block diagram of a controller, external computer, and display device.

FIG. 5 is a block diagram of force control in a robot motion control part.

FIG. 6A is a view detailing the correlation between motion trajectory of a robot and polishing amount.

FIG. 6B is a view detailing the correlation between motion trajectory of a robot and polishing amount.

FIG. 7A is a view detailing the correlation between pressing force and polishing amount.

FIG. 7B is a view detailing the correlation between pressing force and polishing amount.

FIG. 8A is a view detailing the correlation between movement speed and polishing amount.

FIG. 8B is a view detailing the correlation between movement speed and polishing amount.

FIG. 9 shows an example of an image representing a virtual pressing force.

FIG. 10 shows another example of an image representing a virtual pressing force.

FIG. 11 is an example of an augmented reality image in which images representing a virtual pressing force and an estimated polishing amount are overlaid on an actual image.

FIG. 12 is another example of an augmented reality image in which images representing a virtual pressing force and an estimated polishing amount are overlaid on an actual image. FIG. 13 is a view showing an example in which an image representing a recommended trajectory is further overlaid on an image such as that of FIG. 11.

FIG. 14 is a view showing an example in which an image representing a recommended speed is further overlaid on an image such as that of FIG. 11.

FIG. 15 is a view detailing a polishing area.

FIG. 16 is a view detailing a polishing area.

FIG. 17 is a view detailing a polishing area calculation method.

FIG. 18 is a view showing a first example of a polishing tool type and a polishing amount.

FIG. 19 is a view showing a second example of a polishing tool type and a polishing amount.

FIG. 20 is a view showing a third example of a polishing tool type and a polishing amount.

### DETAILED DESCRIPTION OF EMBODIMENTS OF THE INVENTION

Next, the embodiments of the present disclosure will be described with reference to the drawings. In the referenced drawings, identical constituent portions or functional portions have been assigned the same reference sign. In order to facilitate understanding, the scales of the drawings have been appropriately modified. Furthermore, the forms shown in the drawings are merely one example for carrying out the present invention. The present invention is not limited to the illustrated forms.

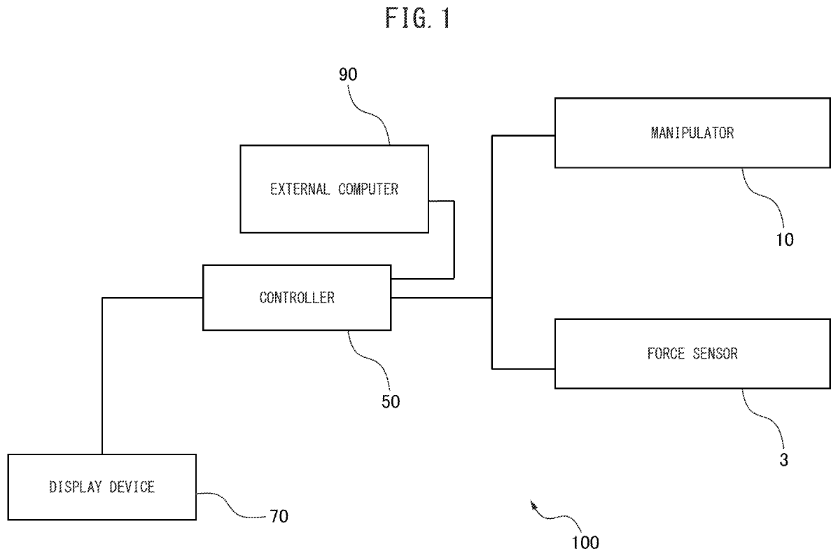

FIG. 1 is a system configuration view of a robot system 100 comprising a controller 50 as a polishing amount estimation device according to an embodiment. As shown in FIG. 1, a robot manipulator 10 (hereinafter described as manipulator 10) having a tool mounted on a wrist tip thereof, and a force sensor 3 as a force detector for detecting external forces applied to the tool are connected to the controller 50. The force sensor 3 is attached between the tip of the wrist of the manipulator 10 and the tool. By providing a force control function, the controller 50 can cause the manipulator 10 to perform various operations such as exploration operations, precision fitting operations, and polishing, which are advanced operations, while detecting the forces applied to the workpiece. The controller 50 may have a configuration as a general computer having a CPU, ROM, RAM, storage device, operation unit, display unit, input/output interface, network interface, etc.

Further, an external computer 90 which is responsible for functions for executing a physics simulation based on an operation model of the manipulator 10 when the controller 50 executes a simulation of the force control operation (hereinafter referred to as force control simulation), and a display device 70 on which force control simulation results are displayed are connected to the controller 50. Note that as used herein, the term “simulation” encompasses not only operations of calculating the position of the manipulator or the like by numerical simulation, but also the case in which a shape model of the manipulator or the like is simulated in accordance with teaching data or the like.

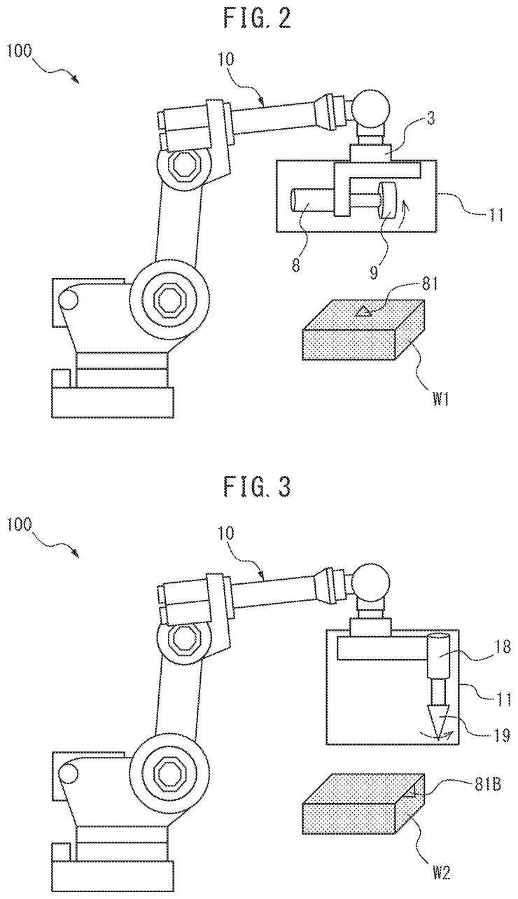

FIGS. 2 and 3 show structural examples of the robot system 100. Furthermore, in FIGS. 2 and 3, only the manipulator 10 (including the force sensor 3 and the tool part 11) and the target workpiece are shown. FIG. 2 shows a configuration example in which a grinder 8 for executing a polishing operation on a workpiece W1 is mounted on a tool part 11. A disk-shaped grindstone 9 is attached to the grinder 8. The grinder 8 is suitable for polishing a burr 81 on the upper surface of the target workpiece W1, as shown in FIG. 2. FIG. 3 shows a configuration example in which a grinder 18 having a triangular pyramid-shaped grindstone 19 is mounted on the tool part 11. The grinder 18 is suitable for polishing a burr 81B formed on the side surface of the target workpiece W2, as shown in FIG. 3.

The controller 50 has functions for estimating the polishing amount when the polishing operation is performed in accordance with teaching data (motion program), and for displaying estimation results of the polishing amount on the display device 70 as an AR (augmented reality) image or VR (virtual reality) image. As a result, for example, the operator can understand how much the polishing amount will be and adjust the teaching data, force control parameters, etc., before actually executing the polishing operation.

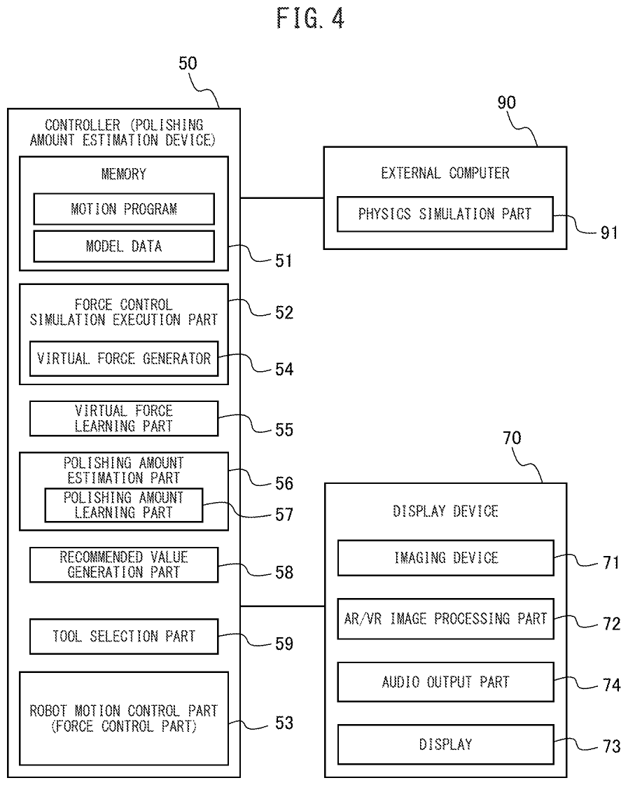

FIG. 4 is a functional block diagram of the controller 50, the external computer 90, and the display device 70. As shown in FIG. 4, the controller 50 comprises a memory 51 in which various information is stored, a force control simulation execution part 52 which controls the execution of force control simulation, a robot motion control part 53 which controls the operation of the robot manipulator 10, a virtual force generator (virtual force generation part) 54, a virtual force learning part 55, a polishing amount estimation part 56 which performs operations for polishing amount estimation, a polishing amount learning part 57, a recommended value generation part 58, and a tool selection part 59. The motion program of the robot manipulator 10, 3D model data of the manipulator 10, tools, workpieces, etc., force control parameters, and other various data used to control the manipulator 10 are stored in the memory 51. The virtual force generator 54 generates a virtual force which is received by the tool part 11 from the target workpiece in a state in which the tool part 11 is in contact with the target workpiece based on the position information of the tool part 11 obtained from the motion program or the simulation results of the force control operation. In the present description, the force virtually obtained as a force acting on an object in this manner be described as a virtual force, and when it is a pressing force, it may also be described as a virtual pressing force.

The external computer 90 comprises a physics simulation part 91 which executes a physics simulation of the manipulator 10 based on a motion model (equation of motion) of the manipulator 10.

In the present embodiment, the display device 70 is configured as a head-mounted display. The display device 70 can also be constituted by another information processing device such as a tablet terminal on which a camera is mounted. The operator wears the display device 70 configured as a head-mounted display. The display device 70 includes an imaging device 71, an AR/VR image processing part 72 which executes image processing for displaying an augmented reality (AR) image or a virtual reality (VR) image, a display 73, and an audio output part 74. The imaging device 71 is provided on the display device 70 so that the optical axis of the image pickup lens faces forward, and captures an image of an actual work space including the manipulator 10. Using the information of the estimated polishing amount obtained by the polishing amount estimation part 56, the AR/VR image processing part 72 executes augmented reality image processing, in which an image representing the estimated polishing amount is overlaid on the actual image, or virtual reality image processing in which an image representing the estimated polishing amount is overlaid on an image (video animation) in a virtual reality space in which a model of each object such as the manipulator 10 is arranged. The display 73 is arranged in front of the wearer and displays images (video) generated by the AR/VR image processing part 72.

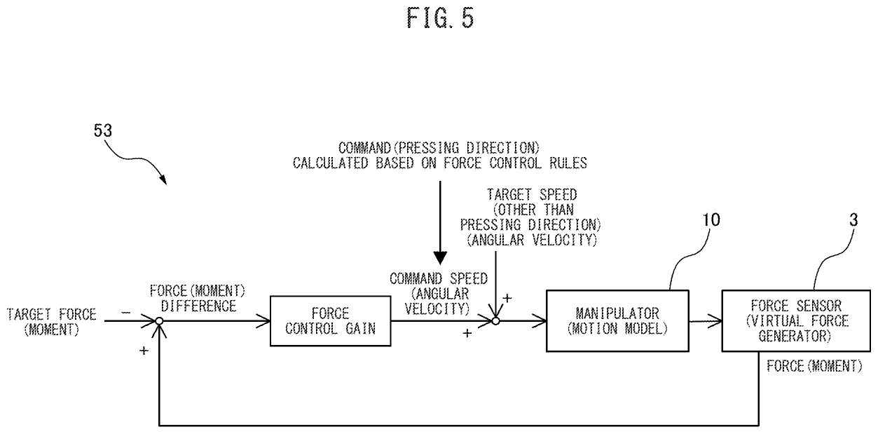

FIG. 5 is a block diagram of force control of the robot motion control part 53. In the present embodiment, the direction of “force control+position control” (the direction in which the workpiece is pressed by the tool) and the direction of only position control are separate, and the manipulator 10 is controlled by synthesizing the speed (angular velocity) command calculated for the direction in which “force control+position control” should be performed and the speed (angular velocity) command calculated for the direction in which only position control should be performed. Though omitted in FIG. 5 for convenience of explanation, the position control is performed based on the position control rule (for example, PD control) generally known in the technical field in which position sensors provided on respective axes of the manipulator 10 feed-back position detection values to control the position. In the force control shown in FIG. 5, the command speed (angular velocity) is calculated by multiplying the difference between the target force (force+moment) in the pressing direction and the force (moment) acting on the workpiece detected by the force sensor 3 by the force control parameter, which is referred to as force control gain. The force control gain represents the performance of the force control, and has the property that the larger the value, the faster the correction of the position/posture. The detection of the force (moment) and the calculation of the corresponding velocity (angular velocity) command amount are performed for each control cycle. Force control rules (calculation formula of velocity (angular velocity) command amount) in this case can be expressed as follows.

Δx=Kf(F−Fd)

where Kf: force control gain,

Fd: target force (force+moment, force: Fx, Fy, Fz, moment: Mx, My, Mz),

F: detected force, and

Δx: target movement amount (speed) for each control cycle.

Next, the polishing amount estimation procedure executed by the polishing amount estimation part 56 will be described. The polishing amount estimation part 56 estimates the polishing amount in the polishing operation using polishing amount estimation procedure 1 or 2 shown below.
(Polishing amount estimation procedure 1): The motion trajectory, movement speed, and pressing force of the robot are considered as parameters which correlate with the polishing amount. In the polishing amount estimation procedure, one of these parameters is used to derive the correlation with the polishing amount by linear approximation or curve approximation. Note that in the present description, the term “motion trajectory” includes a teaching trajectory, which is a so-called trajectory by teaching, as well as a motion trajectory of the manipulator 10 (tool tip) obtained by numerical simulation or the like. As the pressing force used for polishing amount estimation, a virtual force (virtual pressing force) generated by a method described later is used.
(Polishing amount estimation procedure 2): Training data which associates the motion trajectory, movement speed, and pressing force of the robot with the polishing amount is collected, and a learning model which associates these parameters with the polishing amount is built by machine learning.

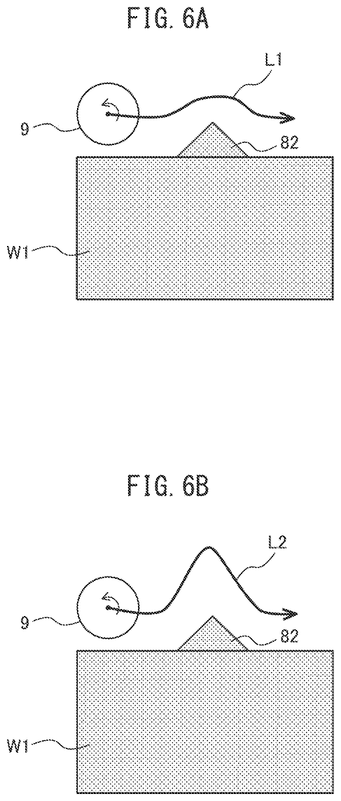

Polishing amount estimation procedure 1 will be described. First, the correlation of robot motion trajectory, movement speed, and pressing force with polishing amount will be described. FIGS. 6A and 6B are views detailing the correlation between the motion trajectory (teaching trajectory) of the robot and the polishing amount. In the teaching trajectory L1 shown in FIG. 6A, the case in which the teaching trajectory L1 of the grindstone 9 is an appropriate trajectory and the polishing amount is also appropriate is shown. In FIG. 6B, in the teaching trajectory L2 of the grindstone 9, the distance from the surface of the target workpiece W1 is large particularly near the protrusion 82. In this manner, the polishing amount decreases as the teaching trajectory moves away from the target workpiece.

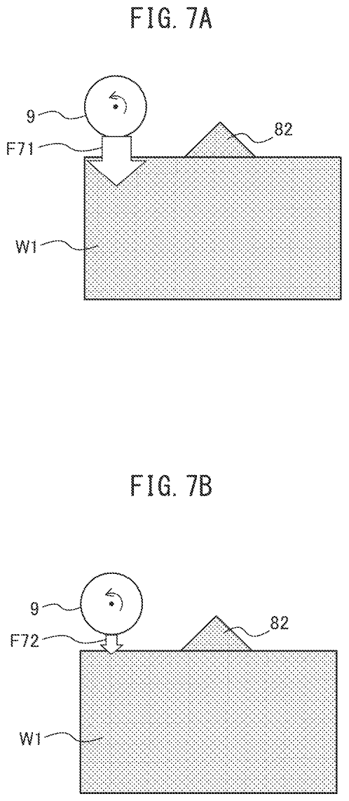

FIGS. 7A and 7B are views for detailing the correlation between pressing force and polishing amount. FIG. 7A shows a case in which the setting of the pressing force (pressing force F71) is appropriate and the polishing amount is also appropriate. Conversely, in FIG. 7B, the setting of the pressing force (pressing force F72) is less than that of the case of FIG. 7A. In this case, the polishing amount decreases even if the teaching trajectory and the teaching speed are the same.

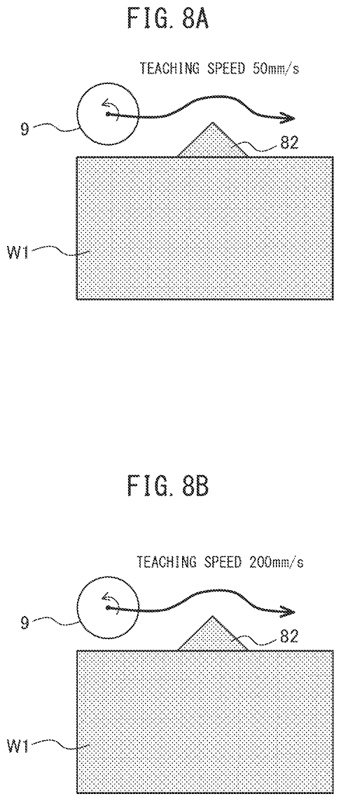

FIGS. 8A and 8B are views for detailing the correlation between movement speed (movement speed of the grindstone along the teaching trajectory) of the tool and polishing amount. FIG. 8A shows a case in which the movement speed setting (teaching speed) is appropriate and the polishing amount is also appropriate. Conversely, in FIG. 8B, the movement speed is set faster than that of the case of FIG. 8A. In the case of FIG. 8B, the time required for polishing is reduced as compared with the case of FIG. 8A, whereby the polishing amount is reduced even if the teaching trajectory and the pressing force are the same.

As described above, each of the motion trajectory, movement speed, and pressing force of the robot has a correlation with the polishing amount. Thus, the estimation of the polishing amount can be performed using any of a calculation model in which the correlation between the motion trajectory of the robot (the distance between the motion trajectory and the surface of the target workpiece) and the polishing amount is linearly or curvedly approximated (a second degree or greater polynomial approximation, logarithmic approximation, etc.) based on actual measurement data, a calculation model in which the correlation between the movement speed of the robot and the polishing amount is linearly or curvedly approximated based on actual measurement data, and a calculation model in which the correlation between the pressing force and the polishing amount is linearly or curvedly approximated based on actual measurement data. Note that such linear approximation or curve approximation of the correlation may be performed for each type of target workpiece and each type of abrasive (grindstone). The correlation between two or more variables of the motion trajectory, movement speed, and pressing force of the robot and the polishing amount may be predicted by multiple regression analysis.

In polishing amount estimation procedure 1, the virtual pressing force acting on the target workpiece during the polishing operation is determined from the positional relationship between the teaching trajectory and the target workpiece, or by virtual force generation methods 1 to 3, which are described below.

(Virtual force generation method 1): The motion model (equation of motion) of the robot manipulator 10 is set, and the operation of the block diagram of the force control shown in FIG. 5 is executed by physics simulation. The virtual pressing force acting on the target workpiece is determined by a calculation model based on the position of the tool tip obtained by the physics simulation. Specifically, in the case of the virtual force generation method 1, a motion model is set for the manipulator 10, as shown in FIG. 5, and the virtual pressing force is calculated by the virtual force generator 54. In other words, the virtual force generator 54 functions as a force sensor in the force control simulation.

(Virtual force generation method 2): The virtual force (virtual pressing force) is obtained using log data including the force (moment) detected by force sensor 3 and the position information of the robot (manipulator 10) when the operation by force control has been executed in the past in the same operating environment or using log data obtained by detecting and recording the force (moment) acting on the workpiece by the force sensor by stopping the driving of the tool (for example, the rotational driving of the polishing grindstone) while actually moving the robot with respect to the target workpiece using the motion program. In the case of the virtual force generation method 2, the distance between the tool and the target workpiece can be determined from the teaching trajectory, and when there is log data of the same degree in terms of the distance between the motion trajectory of the robot and the target workpiece, the pressing force recorded as log data can be used as the virtual force (virtual pressing force).

(Virtual force generation method 3): In the actual operation related to a specific workpiece, training data representing the correspondence between the relative position or speed of the robot (tool) and the workpiece and the force (moment) detected by the force sensor is collected, and a learning model is constructed by the learning function to obtain the virtual force (virtual pressing force).

Virtual force generation method 1 will be described in detail. In virtual force generation method 1, the equation of motion (motion model) of the robot manipulator 10 is set, the force control blocks shown in FIG. 5 are operated by physical (numerical) simulation, and the position of the robot manipulator 10 (the position of the tip of the tool) is determined. The equation of motion of the robot manipulator 10 is generally expressed by the following mathematical formula.

M(θ,\ddot{θ})+h(θ,\dot{θ})+g(θ)=τ+ρ_{L}

In the above formula, θ represents the angle of each joint, M is a matrix related to the moment of inertia, h is a matrix related to the Coriolis force and centrifugal force, g is a term representing the influence of gravity, τ is torque, and τ_{L} is load torque.

The motion command based on the teaching trajectory (command given to the manipulator 10 in the example of FIG. 5) is input into the equation of motion as input data to calculate the behavior of the robot (position of the tip of the tool). Based on the tool tip position calculated based on the above equation of motion, the virtual force (virtual pressing force) F received from the workpiece when the tool tip position contacts the target workpiece is determined. Examples of the calculation of the virtual force F are shown below.

The first calculation example of the virtual pressing force F is an example in which the rigidity of the target workpiece is relatively low with respect to the tool. In the present example, the amount by which the tool tip position moves beyond the contact position with the target workpiece to the target workpiece side is defined as δ, and the virtual force F may be determined from the following formula:

F=Kd·δ (1a)

by multiplying by coefficient Kd regarding the rigidity of the workpiece. Note that in this case, it is assumed that the target workpiece has a fixed position in the work space. Alternatively, there may be used a procedure in which the force F received from the workpiece when the position of the tool tip contacts the target workpiece is calculated from the following formula:

F=Kd·δ+Kc·Vc (1b)

wherein Vc represents the velocity when the tool tip position moves beyond the contact position with the target workpiece. The coefficients Kd and Kc can be set in accordance with the rigidity and shape of the target workpiece.

The second calculation example of the virtual pressing force F is an example in which the virtual force F is calculated based on the amount of deflection of the tool when the rigidity of the tool is relatively low with respect to the target workpiece. The amount δ that the tool tip position moves beyond the contact position with the target workpiece to the target workpiece side is considered as the amount of deflection of the tool, and the virtual force F is calculated by the following formula using the rigidity coefficient (virtual spring constant) of the tool.

F=(tool virtual spring constant)×δ (2a)

Note that if the tool is a so-called floating tool which has a mechanism (spring mechanism) that expands and contracts in the pressing direction, the expansion and contraction length of the tool tip can be obtained based on the position of the tool tip and the position of the target workpiece, and the virtual force F can be obtained by the following formula.

F=(tool spring constant)×expansion/contraction length (2b)

The third calculation example of the virtual force (virtual pressing force) F is an example in which the virtual force F is calculated from the distance that the robot (tool tip) moves in the pressing direction in response to the speed command when the rigidity of the tool is relatively high. In the case of this example, the movement position according to the speed command is defined as Tx, the position to which the robot (tool tip) actually moves in response to the speed command is defined as d, and calculation is performed by the following formula.

F=k×(Tx−d) (3)

where k is a coefficient. A value obtained as an experimental value, an empirical value, or the like may be set as the coefficient k.

In the calculation examples described above, the virtual force may be obtained by using teaching data (teaching trajectory, teaching speed) instead of the position and speed of the tool tip by physics simulation.

Next, the virtual force generation method 3 will be described in detail. The generation of the virtual pressing force by the virtual force generation method 3 is executed by the virtual force learning part 55. The virtual force learning part 55 has functions to extract useful rules, knowledge representations, judgment criteria, etc., in the set of input data by analysis, output the judgment results, and perform knowledge learning (machine learning). There are various methods of machine learning, but they can be broadly divided into, for example, “supervised learning”, “unsupervised learning”, and “reinforcement learning.” Furthermore, in order to realize these methods, there is a method called “deep learning” in which the extraction of feature amounts themselves are learned. In the present embodiment, “supervised learning” is adopted as the machine learning by the virtual force learning part 55.

As described in the section “Virtual force generation method 2” above, in a state in which the tip of the tool and the target workpiece are in contact, it is considered that the relative distance between the tool tip position and the workpiece, the relative velocity, the coefficient related to the rigidity or dynamic friction of the target workpiece, the coefficient related to the rigidity of the tool, etc., correlate with the magnitude of the pressing force. Thus, the virtual force learning part 55 executes learning using learning data in which these values which correlate with the magnitude of the pressing force are used as input data and the pressing force detected by the force sensor is used as response data.

As a specific example of building a learning model, there may be an example of constructing a learning model corresponding to the first to third calculation examples of the virtual force F described above. When constructing a learning model corresponding to the first calculation example of the virtual force F, learning data in which the relative distance (δ) between the tool tip position and the target workpiece, relative velocity (Vc), and values related to the rigidity of the target workpiece (Kd, Kc) (or alternatively, at least the relative distance (δ) between the tool tip position and the target workpiece and the value related to the rigidity of the workpiece (Kd)) are used as the input data and the pressing force detected by the force sensor in that case is used as the response data is collected. The learning model is constructed by executing learning using the learning data.

When constructing a learning model corresponding to the second calculation example of the virtual force F, learning data in which the amount of movement of the tool tip position (δ) and the “virtual spring constant of the tool” are used as input data and the pressing force detected by the force sensor is the response data is collected. The learning model is constructed by executing learning using the learning data. Note that learning data (training data) composed of input data including at least one of the coefficient related to the rigidity of the target workpiece and the coefficient related to the rigidity of the tool part, and the distance (δ) of the tool part to the target workpiece when the tool part is in contact with the target workpiece and response data, which is the pressing force detected by the force sensor in that case, may be collected, and the learning model may be constructed by executing learning using the learning data.

When constructing a learning model corresponding to the third calculation example of the virtual force F, learning data in which the moving position (Tx) according to the speed command and the position (d) to which the tip of the tool actually moved in response to the speed command are used as input data and the pressing force detected by the force sensor in that case is used as the response data is collected. The learning model is constructed by executing learning using the learning data. The learning in this case corresponds to the operation of learning the coefficient k.

Such learning can be realized using a neural network (for example, a three-layer neural network). The operation modes of the neural network include a learning mode and a prediction mode. In the learning mode, the training data (input data) described above is input as an input variable to the neural network, and the weight applied to the input of each neuron is learned. Weight learning is executed by determining the error between the output value and the correct answer value (response data) when the input data is input to the neural network, and back-propagating the error to each layer of the neural network and adjusting the weight of each layer so that the output value approaches the correct answer value. When a learning model is constructed by such learning, it is possible to predict the virtual pressing force using the input data described above as an input variable.

The audio output part 74 outputs a sound which expresses the magnitude of the virtual force generated by the virtual force generator 54 in accordance with the volume. For example, the operator can more intuitively understand the magnitude of the virtual force by outputting a sound corresponding to the magnitude of the virtual force generated by the virtual force generator 54 in real time during the execution of the force control simulation.

Next, polishing amount estimation procedure 2 will be described. In polishing amount estimation method 2, learning is performed by the polishing amount learning part 57. As described above, the motion trajectory, movement speed, and pressing force (virtual pressing force) of the robot each have a correlation with the polishing amount. The polishing amount learning part 57 constructs a learning model that associates these parameters with the polishing amount by machine learning. Here, “supervised learning” is adopted as machine learning.

The learning in this case can be configured using, for example, a neural network (for example, a three-layer neural network). In the learning mode, the learning data (robot motion trajectory, movement speed, and virtual pressing force) described above is input as an input variable to the neural network, and the weight applied to the input of each neuron is learned. Weight learning is executed by determining the error between the output value and the correct answer value (response data; polishing amount) when the input data is input to the neural network, and back-propagating the error to each layer of the neural network and adjusting the weight of each layer so that the output value approaches the correct answer value. When a learning model is constructed by such learning, it is possible to estimate the polishing amount by inputting the motion trajectory, movement speed, and virtual pressing force of the robot.

The controller 50 (polishing amount estimation part 56) displays, on the display device 70, an image representing the virtual pressing force generated using the virtual force generation methods 1 to 3 described above and the polishing amount estimated using either polishing amount estimation procedure 1 or 2 described above, as an augmented reality image or virtual reality image. The controller 50 (polishing amount estimation part 56) supplies information representing the magnitude and location of the virtual pressing force obtained by executing the force control simulation of the polishing operation and the polishing amount estimation result (polishing position and polishing amount) to the display device 70. The AR/VR image processing part 72 of the display device 70 overlays and displays an image representing the virtual pressing force and the estimated polishing amount at a position corresponding to the locations where they occur in the real space image or the virtual space image. When generating a virtual reality image, for example, the model data and the arrangement position information of each object in the work space including the manipulator 10 may be provided from the controller 50 to the display device 70. Note that the display device 70 has a position sensor (optical sensor, laser sensor, or magnetic sensor) and an acceleration sensor (gyro sensor) for acquiring the position of the display device 70 in the work space, whereby the relative positional relationship of the coordinate system (camera coordinate system) fixed to the display device with respect to the world coordinate system fixed to the work space can be understood.

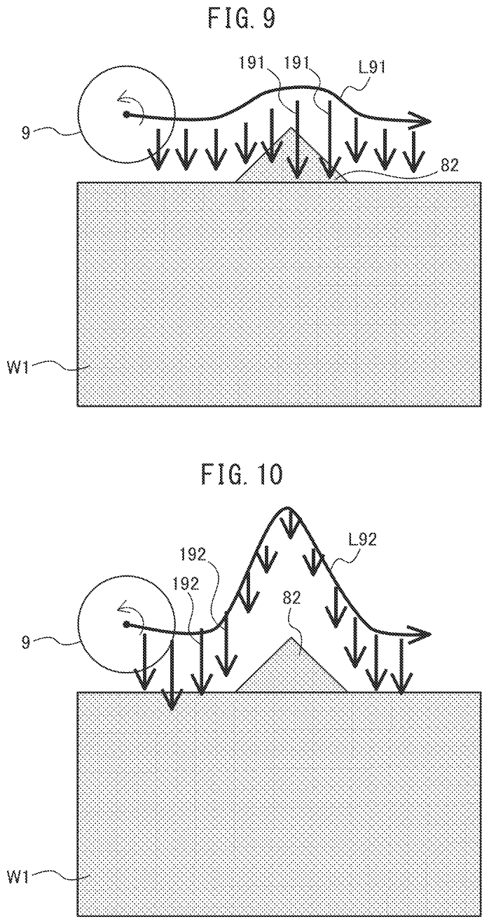

FIGS. 9 and 10 show examples of images representing the virtual pressing force. FIG. 9 shows a display example of an image representing the virtual pressing force when the teaching trajectory L91 is a trajectory that is relatively close to the surface of the target workpiece W1 in the vicinity of the protrusion 82. In the case of FIG. 9, the virtual pressing force is represented by arrows 191, and it is expressed that the virtual pressing force increases in the vicinity of the protrusion 82 where the teaching trajectory L91 is relatively close to the surface of the target workpiece W1. FIG. 10 shows a display example of an image representing the virtual pressing force when the teaching trajectory L92 is a trajectory which is relatively separated from the surface of the target workpiece W1 in the vicinity of the protrusion 82. In the case of FIG. 10, the virtual pressing force is represented by the arrows 192, and it is expressed that the virtual pressing force becomes smaller in the vicinity of the protrusion 82 where the teaching trajectory L92 is relatively far from the surface of the target workpiece W1.

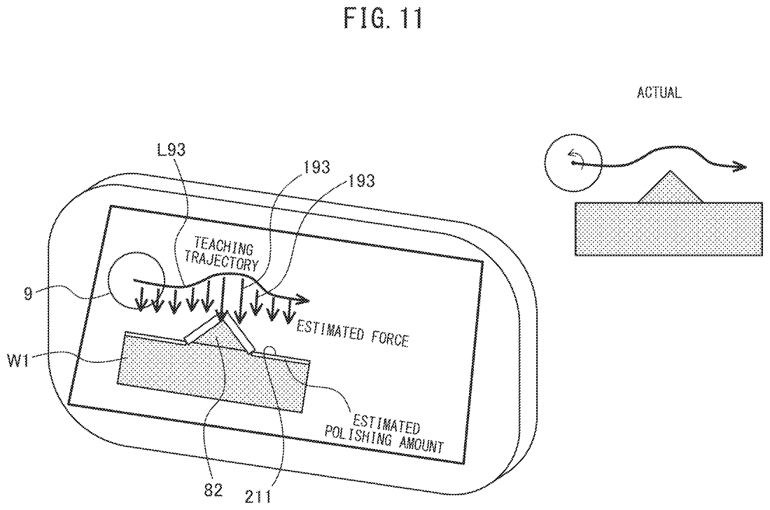

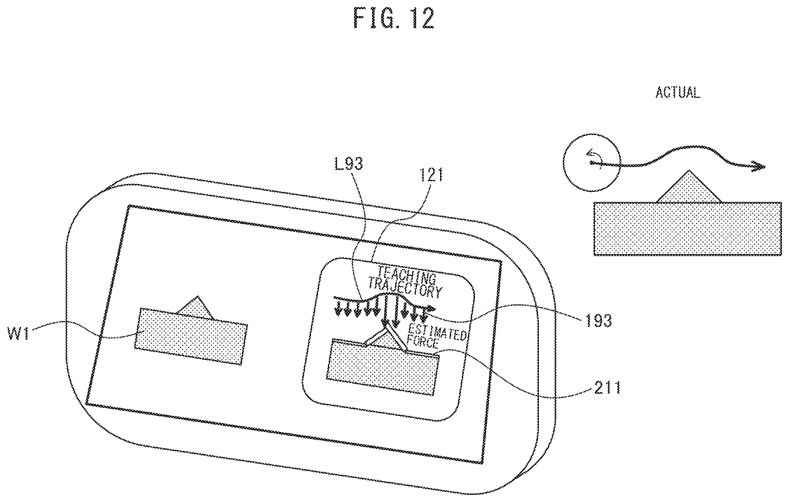

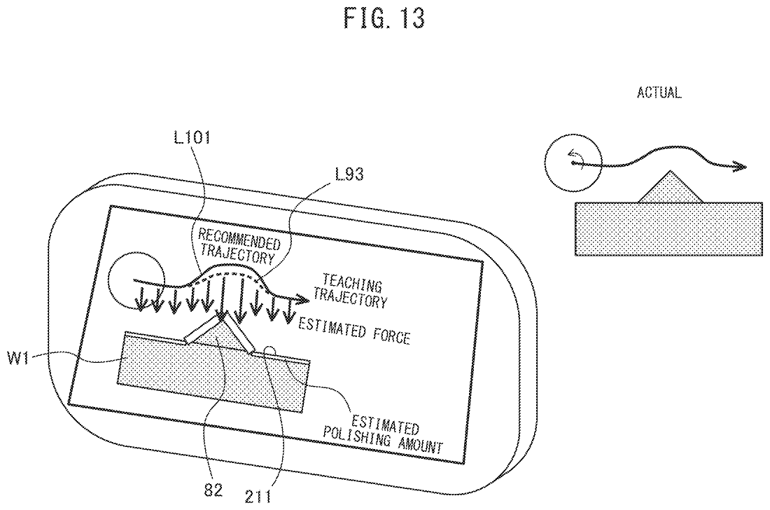

Next, an example of an augmented reality image in which an image representing a virtual pressing force and an estimated polishing amount is superimposed and displayed on a real image will be described with reference to FIGS. 11 and 12. In the example of FIG. 11, an image L93 representing the teaching trajectory, an image 193 representing the generation position and magnitude of the virtual pressing force by the length of an arrow, and an image 211 representing the estimated polishing amount are overlaid and displayed on an actual image including the grindstone 9 and the target workpiece W1. It can be understood from the image example of FIG. 11 that the virtual pressing force becomes relatively large in the area of the protrusion 82, and the estimated polishing amount in the region of the protrusion 82 is greater than that in the region where the protrusion 82 is not present. Note that the image L93 representing the teaching trajectory, the image 193 representing the virtual pressing force, and the image 211 representing the estimated polishing amount are created as images representing a three-dimensional region. In this case, the operator can visually understand the virtual pressing force and the estimated polishing amount from the desired line-of-sight direction by moving the line of sight.

FIG. 12 shows an example of the case in which an image 121 including the image L93 representing the teaching trajectory, the image 193 representing the generation position and magnitude of the virtual pressing force by the length of the arrow, and the image 211 representing the estimated polishing amount shown in FIG. 11 are overlaid and displayed as an augmented reality image side by side with target workpiece W1 in a real image. For example, when the amount of information to be provided as an augmented reality image is large, it may be convenient for the operator (wearer) to display the augmented reality image side by side on the image as shown in FIG. 12.

The recommended value generation part 58 has a function for displaying an image of advice on how to adjust motion trajectory, movement speed, force control gain, etc., for adjusting the estimated polishing amount based on the result of comparison between the estimated polishing amount and a polishing amount reference value representing the desired polishing amount. FIG. 13 shows an example of the case in which an image L101 representing the recommended trajectory is displayed to reduce the estimated polishing amount in the area of the protrusion 82 since the estimated polishing amount exceeds the polishing amount reference value in the area of the protrusion 82 when the estimated polishing amount (image 211) shown in FIG. 11 is compared with the polishing amount reference value. In the image L101 of the recommended trajectory, the distance from the target workpiece W1 in the vicinity of the protrusion 82 is greater than in the case of the image L93 representing the teaching trajectory. As a result, in the case of the recommended trajectory (image L101), the estimated polishing amount can be suppressed within the polishing amount reference value.

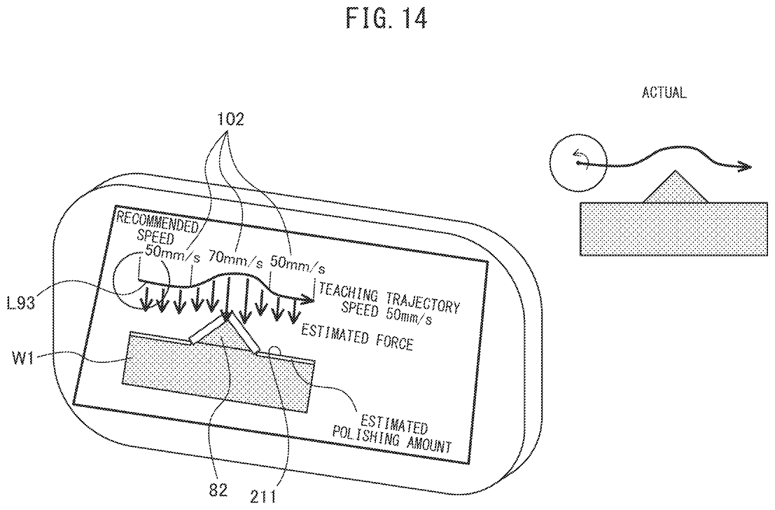

FIG. 14 shows an example in which a recommended value regarding the movement speed of the robot (tool) is presented. In the example of FIG. 14, an image representing the teaching speed is displayed next to the teaching trajectory (image L93), and an image 102 representing the recommended speed is displayed for each division of the teaching trajectory (image L93). In the case of the example of FIG. 14, the teaching velocity for the teaching trajectory (image L93) is 50 mm/s, whereas the recommended speed is 70 mm/s in the area of the protrusion 82 of the target workpiece W1 and 50 mm/s in other areas. In the case of this recommended speed, the speed in the area of the protrusion 82 becomes higher than the teaching speed, and thus, the estimated polishing amount decreases and falls within the polishing amount reference value.

For the recommended value generation part 58, parameters used for adjustment may be specified, for example, via the operation unit of the controller 50. For example, when the operator does not want to change the teaching trajectory due to concerns about increased cycle time, parameters other than teaching trajectory (teaching speed, target pressing force, etc.) can be specified as a parameter to be adjusted by the recommended value generation part 58.

Regarding the recommended value described above, the recommended value generation part 58 compares the estimated polishing amount with the polishing amount reference value, and for example, when the estimated polishing amount is greater than the polishing amount reference value, the motion trajectory, movement speed, force control parameter, etc., are adjusted in the direction of decreasing the estimated polishing amount, which is confirmed by executing the force control simulation.

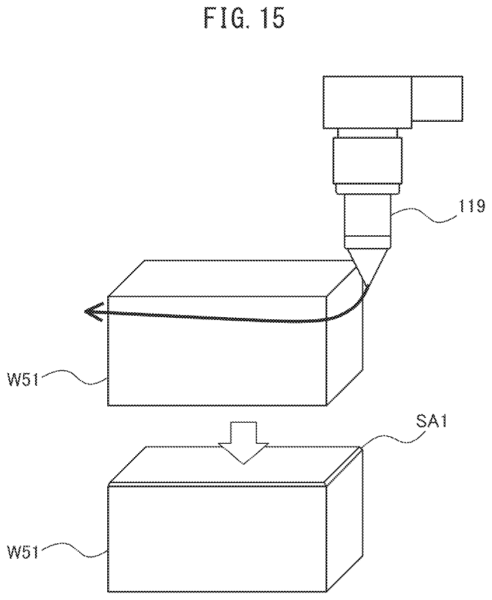

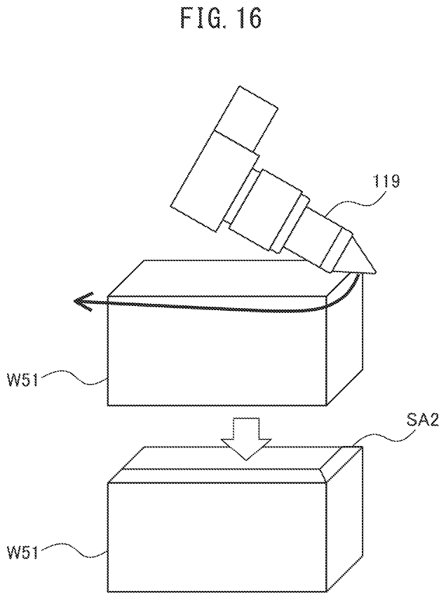

The polishing amount estimation part 56 may be configured to calculate the area of the target workpiece polished by the polishing member (hereinafter referred to as polishing area). Even when the same polishing member is used, the polishing area changes depending on the angle of the polishing member with respect to the target workpiece. For example, when the polishing area SA1 when polishing is performed by the polishing member 119 which is brought into contact with the target workpiece W51 in an upright polishing posture, as shown in FIG. 15, and the polishing area SA2 when polishing is performed by contacting the polishing member 119 with the target workpiece W51 in a lying posture, as shown in FIG. 16 are compared with each other, the polishing area SA2 is larger.

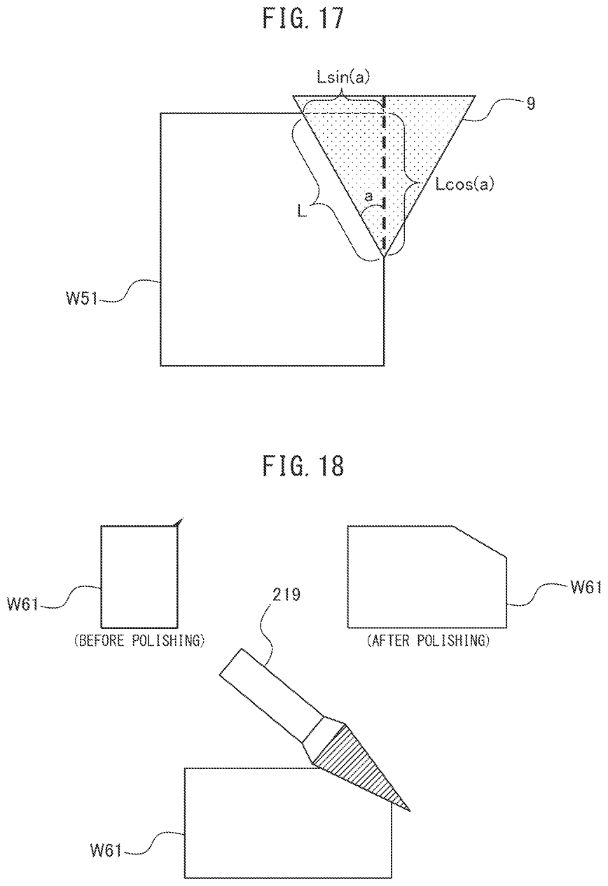

The polishing amount estimation part 50 calculates the polishing area as follows. Let us consider a case where, as shown in FIG. 17, the polishing area SL when the polishing member 9 is applied to the target workpiece W51 is obtained. In this case, it is assumed that the pressing force acting on the target workpiece from the tool (polishing member 9), the amount of rotation of the tool (polishing member 9), the material, and the moving speed do not change. Further, it is assumed that the total polishing amount does not change even if the tool (polishing member 9) is inclined. V is the volume of the portion cut by polishing, d is movement amount of the tool (polishing member 9) (movement amount in the depth direction of the paper surface in FIG. 17), and a is the tool tip angle. L represents the length of the cut inclined surface. In this case, the following formula holds.

V/d=(1/2)·L sin(a)·L cos(a)

Assuming that V/d is constant, the above formula can be modified as follows.

2V/d=L² sin(a)·cos (a)

2V/d=(L² sin(2a))/2

From the foregoing, the length L of the cut surface can be obtained as follows.

L=(4V/(d/sin (2a)))^{1/2}

The polishing area can be obtained by multiplying the length L by the movement amount d of the tool.

The tool selection part 59 has a function for accepting a user selection from a plurality of types of tools stored in advance, for example, via the operation unit of the controller 50 or a function for automatically selecting an appropriate tool and posture based on information such as polishing amount, polishing area, cycle time, etc. The force control simulation execution part 52 virtually installs the tool selected by the tool selection part 59 onto the manipulator 10 and executes the force control simulation. FIG. 18 shows an example of a polishing tool and a posture selected when a relatively large area is required or allowed as a polishing area of the target workpiece W61. In the example of FIG. 18, the polishing member has a long shape, and a wide polishing area is secured by using the polishing member in a lying posture with respect to the target workpiece W61.

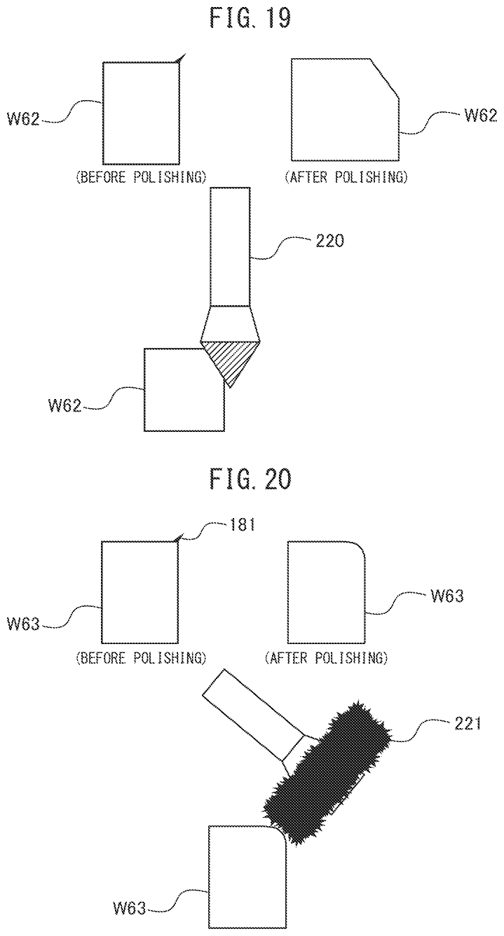

FIG. 19 shows an example of a polishing tool and a posture selected when a relatively narrow polishing area of the target workpiece W62 is required. In the case of the example shown in FIG. 19, a polishing tool having a relatively short length is selected, and the posture of the polishing tool is a posture standing with respect to the target workpiece W62. In this case, the polishing area can be narrowed.

FIG. 20 shows an example of a polishing tool and a posture selected when reducing the polishing amount and polishing area. In the case of the example of FIG. 20, a polishing tool 221 having a metal brush is selected as the polishing member, and the peripheral surface of the polishing member is in contact with the portion of the burr 181 on the target workpiece W63 (the center line of the polishing tool is inclined at an angle of approximately 45 degrees with respect to the vertical direction).

Note that regarding the relationship of the material of the polishing tool and the material of the target workpiece with the polishing amount, it is possible to obtain the correlation based on the following idea. On the polishing tool side, since the roughness of the abrasive grains is more strongly related to the polishing amount than the rigidity, actual measurement data may be taken for each roughness of the abrasive grains to predict the polishing amount. For example, an approximate model of polishing amount is set so that the polishing amount increases as the roughness of the abrasive grains increases. Regarding the workpiece, depending on the material of the workpiece, it may be difficult to cut. Thus, as an index showing the rigidity of the material, there are Young's modulus, which shows ductility, and plastic coefficient, which shows plasticity, and these coefficients may be used as-is or in terms of (1/Young's modulus) as a coefficient representing the polishing amount. Alternatively, in the case of a workpiece, actual measurement data may be taken for the amount of cutting with respect to the rigidity of the material, an approximate model may be obtained, and the polishing amount may be predicted.

As described above, according to the present embodiment, the operator can intuitively understand the estimated polishing amount, and the teaching trajectory and force control parameter can be easily adjusted.

Though the present invention has been described above using typical embodiments, a person skilled in the art would appreciate that modifications and various other modifications, omissions, and additions can be made to each of the above embodiments without departing from the scope of the invention.

The division of functions in the controller 50, display device 70, and external computer 90 in the embodiments described above are exemplary, and the arrangement of these functional blocks can be changed. The imaging device may be arranged in a fixed position in the work space as a separate device from the display device.

The functional blocks of the controller and display device may be realized by the CPU of the devices executing the various software stored in the storage device, or alternatively, may be realized by a hardware-based configuration such as an ASIC (Application Specific Integrated IC).

The program for executing the various simulation processes in the embodiments described above can be recorded on various recording media that can be read by a computer (for example, semiconductor memory such as ROM, EEPROM, or flash memory, magnetic recording medium, or an optical disc such as a CD-ROM or DVD-ROM).

### REFERENCE SIGNS LIST

3 force sensor
10 robot manipulator
11 tool part
50 controller
51 memory
52 force control simulation execution part
53 robot motion control part
54 virtual force generator
55 virtual force learning part
56 polishing amount estimation part
57 polishing amount learning part
58 recommended value generation part
59 tool selection part
70 display device
71 imaging device
72 AR/VR image processing part
73 display
74 audio output part
90 external computer
91 physics simulation part
100 robot system

1. A polishing amount estimation device for estimating a polishing amount in a polishing operation which is performed by bringing a polishing tool mounted on a robot manipulator into contact with a target workpiece by force control, the polishing amount estimation device comprising:
a memory which stores a motion program, and
a polishing amount estimation part configured to estimate the polishing amount based on at least one of a motion trajectory of the polishing tool, a movement speed of the polishing tool, and a pressing force of the polishing tool against the target workpiece, which are obtained based on the motion program.

2. The polishing amount estimation device according to claim 1, wherein the memory further stores a force control parameter, which is a parameter related to the force control,
the polishing amount estimation device further comprises a force control simulation execution part configured to execute a simulation of the force control based on the motion program and the force control parameter, and
the force control simulation execution part determines the motion trajectory, the movement speed, and the pressing force based on position information of the polishing tool obtained from results of the simulation of the force control.

3. The polishing amount estimation device according to claim 2, wherein the force control simulation execution part comprises a virtual force generation part configured to virtually generate, based on the position information of the polishing tool obtained from the results of the simulation of the force control, a pressing force exerted on the target workpiece from the polishing tool in a state in which the polishing tool is in contact with the target workpiece.

4. The polishing amount estimation device according to claim 3, further comprising a physics simulation part configured to execute, using an equation of motion representing the robot manipulator, a physics simulation of motion of the robot manipulator based on the force control parameter, wherein
the virtual force generation part determines the pressing force based on the position information of the polishing tool obtained by the physics simulation in a state in which the polishing tool is in contact with the target workpiece.

5. The polishing amount estimation device according to claim 4, wherein the virtual force generation part determines the pressing force based on any of a coefficient related to rigidity of the target workpiece, a coefficient related to rigidity of the polishing tool, and a spring constant of the polishing tool, as well as a distance of the polishing tool to the target workpiece in a state in which the polishing tool is in contact with the target workpiece.

6. The polishing amount estimation device according to claim 1, wherein the polishing amount estimation part estimates the polishing amount based on any of a model in which a correlation between the motion trajectory of the polishing tool and the polishing amount is linearly or curvedly approximated based on actual measurement data, a calculation model in which a correlation between the movement speed of the polishing tool and the polishing amount is linearly or curvedly approximated based on actual measurement data, and a calculation model in which a correlation between the pressing force of the polishing tool and the polishing amount is linearly or curvedly approximated based on actual measurement data.

7. The polishing amount estimation device according to claim 1, further comprising a polishing amount learning part configured to execute machine learning based on training data composed of input data including a motion trajectory of the polishing tool, a movement speed of the polishing tool and a pressing force of the polishing tool against the target workpiece, and response data, which is an actual polishing amount corresponding to the input data, wherein
the polishing amount estimation part estimates the polishing amount using a learning model constructed by machine learning by the polishing amount learning part.

8. The polishing amount estimation device according to claim 1, further comprising:
an imaging device which captures an image of an actual workspace including the robot manipulator and the target workpiece; and
a display device which superimposes an image representing the estimated polishing amount on the image of the workspace as an augmented reality image.

9. The polishing amount estimation device according to claim 1, wherein the memory further stores model data representing shapes of the robot manipulator, the polishing tool and the target workpiece and information on arrangement positions of the robot manipulator, the polishing tool and the target workpiece, and
the polishing amount estimation device further comprises a display device which superimposes an image representing the estimated polishing amount on a virtual reality image arranged in a virtual workspace including the polishing tool and the target workpiece using the model data and the information on the arrangement positions.

10. The polishing amount estimation device according to claim 8, further comprising a recommended value generation part which is configured to generate a recommended adjustment value for a teaching trajectory or the force control parameter based on a result of comparison between the estimated polishing amount and a predetermined polishing amount reference value, wherein
the display device further superimposes an image representing the recommended adjustment value on the image of the actual workspace or the virtual reality image.

11. The polishing amount estimation device according to claim 2, further comprising a tool selection part configured to select a polishing tool to be used from a plurality of types of polishing tools based on information indicating a required polishing amount or polishing area, wherein
the force control simulation execution part virtually installs the selected polishing tool to the robot manipulator and executes a simulation of the force control.
